(19) United States
(12) Patent Application Publication
(10) Pub. No.: US 2009/0278488 A1
(43) Pub. Date: Nov. 12, 2009

(54) METHOD FOR DISCHARGE BALANCING OF A BATTERY ARRAY

(76) Inventors: Kai-Wai Alexander Choi, Houston, TX (US); Sheung Wa Chan, North Point (HK)

Correspondence Address: FULBRIGHT & JAWORSKI L.L.P., 600 CONGRESS AVE., SUITE 2400, AUSTIN, TX, 78701, US

(21) Appl. No.: 12/117,887

(22) Filed: May 9, 2008

(51) Int. Cl. H02J 7/00

(52) U.S. Cl. 320/103

(57) ABSTRACT

A method for discharge balancing for a battery array including a plurality of partitions of battery cells 210 is disclosed. The method includes: transferring charge from a first partition of battery cells to a high capacity storage device 240; and transferring charge from the high capacity storage device 240 to a second partition of battery cell; wherein the capacity of the first partition of battery cells is higher than the capacity of the second partition of battery cells. The method may further include determining the discharge status of each partition of battery cells 210. Charge is transferred from the partition of battery cells with the highest charge capacity to the high capacity storage device 240 based on the discharge status of the partitions. Furthermore, charge may be transferred from the high capacity storage device 240 to a partition of battery cells with the lowest charge capacity based on the discharge status of the partitions.

### TECHNICAL FIELD

The presently claimed invention relates generally electrical charge storage. In particular, the claimed invention relates to a rechargeable battery array and, with greater particularity, to methods for balancing the battery charge during the process of discharging a battery array.

### BACKGROUND

Under the discharge process of a battery array with battery cells connected in series, ideally all battery cells start with the same charge capacity and deliver electric current with the same discharge profile. Accordingly, all battery cells get fully discharged at the same time and the charge capacity of the battery array can be fully utilized. In practice, each battery cell among the battery array has different physical characteristics, such as internal impedance and charge capacity, as a result from manufacturing process variation, non-uniform operating temperatures due to stacking arrangement of the battery cells, or battery degradation. Each battery cell therefore has a discharge profile at least slightly different from the others. Some weaker battery cells may discharge faster and become fully discharged earlier than other battery cells. If the battery array continues to discharge, overdischarge condition may occur. Cell polarity reversal will happen in the fully discharged battery cells and hence cause large current flowing through the battery cells. Eventually, overdischarge condition may cause irreversible damage to the battery cells, breakdown of the power supply circuit, and malfunction of the whole electronic system.

In order to prevent cell reversal in the discharge, the load is usually disconnected from the battery array before full discharge of any of the battery cell. One disadvantage for this method is the waste of charge capacity because most of the battery cells in the battery array are still not yet fully discharged. As the imbalance of battery cell discharge grows with time, the utilization of charge capacity of the battery array will be severely reduced.

Another disadvantage for the known method is the difficulty to detect full discharged condition of the battery cells among a battery array. The discharge condition of an individual battery cell can neither be inferred from the terminal voltage across the whole battery array nor from the discharge current. Additionally, it is costly to install circuit for monitoring the discharge status of each battery cell.

Other known methods have also been adopted to avoid cell reversal by circuit switching to replace the defective cells with backup cells prior to complete discharge. However, the extent of such replacement is limited and system breakdown still occurs when there are more defective cells than the backup cells.

Therefore, the art would benefit greatly from improved methods for battery array discharging such that cell polarity reversal can be avoided and the cell capacity of each battery cell can be efficiently utilized.

### SUMMARY

Discharge balancing among battery cells can be implemented through connecting charge sharing capacitors across different battery cells periodically aiming at equalizing the charge in each battery cell. Nevertheless, the equalization process usually takes a long time to complete because the capacitance of the charge sharing capacitor is not comparable to the charge capacity of the battery cell. Under normal discharge rate of a battery array which may become fully discharged in a few hours, effective equalization of charges is difficult to achieve by charge sharing capacitors. In addition, large capacitors are bulky and take up substantial space in the battery system, hence disadvantageously increases the size and the manufacturing costs.

Accordingly, several aspects of the claimed invention have been developed with a view to substantially reduce or eliminate the drawbacks described hereinbefore and known to those skilled in the art and to provide improved methods for discharging a battery array that may be adopted to offer efficient utilization of cell capacity, and to effectively avoid cell polarity reversal of the weak battery cells. According to embodiments of the claimed invention, there is provided a method for discharge balancing for a battery array including a plurality of partitions of battery cells. The method involves transferring charge from a first partition of battery cells to a high capacity storage device; and transferring charge from the high capacity storage device to a second partition of battery cell; wherein the capacity of the first partition of battery cells is higher than the capacity of the second partition of battery cells. In an exemplary embodiment, the high capacity storage device may comprise at least one charge sharing battery cell.

Advantageously, in certain embodiments, the method further includes determining the discharge status of each partition of battery cells. Charge is transferred from the partition of battery cells with the highest charge capacity to the high capacity storage device based on the discharge status of the partitions.

In further embodiments, charge is transferred from the high capacity storage device to a partition of battery cells with the lowest charge capacity based on the discharge status of the partitions.

The determining of the discharge status of each the partition of battery cell is preferably done by measuring the voltage across the terminals of the corresponding partition of battery cells.

Additionally, the transferring charge from the first partition of battery cells to the high capacity storage device further includes boosting the voltage of the first partition of battery cells to a boosted voltage; and connecting the boosted voltage to the high capacity storage device.

In one embodiment, the charge transfer occurs from the high capacity storage device to the second partition of battery cells may be performed by charge sharing between the high capacity storage device and the second partition of battery cells. In yet another exemplary embodiment, the transferring charge from the high capacity storage device to the second partition of battery cells further includes boosting the voltage of the high capacity storage device to a boosted voltage; and connecting the boosted voltage to the second partition of battery cells.

In a further embodiment, the transferring charge from the first partition of battery cells and transferring charge from the high capacity storage device is repeated until all partitions of battery cells in the battery array are substantially fully discharged. In yet a further embodiment, the transferring charge from the first partition of battery cells and transferring charge from the high capacity storage device until the voltage across each partition of battery cells drops to a predetermined value.

According to another aspect of the present invention, there is provided an apparatus for discharge balancing for a battery array including a plurality of partitions of battery cells. The apparatus includes a first switching circuit for transferring charge from a first partition of battery cells to a high capacity storage device; and a second switching circuit for transferring charge from the high capacity storage device to a second partition of battery cell; wherein the capacity of the first partition of battery cells is higher than the capacity of the second partition of battery cells.

In certain embodiments, the apparatus further includes a voltage comparator for determining the discharge status of each partition of battery cells. In one exemplary embodiment, the first switching circuit transfers charge to the high capacity storage device from a partition of battery cells with the highest charge capacity. In a further exemplary embodiment, the second switching circuit transfers charge from the high capacity storage device to a partition of battery cells with the lowest charge capacity.

Advantageously, in one embodiment, the first switching circuit further includes a boosting circuit for boosting the voltage of the first partition of battery cells to a boosted voltage; and a buffering circuit for connecting the boosted voltage to the high capacity storage device.

In another embodiment, the second switching circuit further includes a charge sharing circuit for transferring charge from the high capacity storage device to the second partition of battery cells. In a further embodiment, the second switching circuit further includes a boosting circuit for boosting the voltage of the high capacity storage device to a boosted voltage; and a buffering circuit for connecting the boosted voltage to the second partition of battery cells.

In yet a further embodiment, the apparatus further includes a controlling circuit for disabling the first switching circuit and the second switching circuit when all partitions of battery cells in the battery array are substantially fully discharged. In an additional embodiment, the controlling circuit disables the first switching circuit and the second switching circuit when the voltage across each partition of battery cells drops to a predetermined value.

Other aspects of the invention are also disclosed.

### BRIEF DESCRIPTION OF DRAWINGS

Embodiments of the invention are described in more detail hereinafter with reference to the drawings, in which:

FIG. 1 is a block diagram showing an exemplary vehicle battery system according to an embodiment of the claimed invention.

FIG. 2 is a block diagram showing an exemplary configuration of the cell module, such as presented in FIG. 1.

FIG. 3 is a flow diagram illustrating an exemplary process for discharge balancing according to an embodiment of the claimed invention.

### DETAILED DESCRIPTION

Improved methods for discharge balancing of a battery array are disclosed herein. In the following description, numerous specific details, including battery array architecture, battery capacity, discharge profile, circuit components and parameters thereof, and the like are set forth. However, from this disclosure, it will be apparent to those skilled in the art that modifications, including additions and/or substitutions may be made without departing from the scope and spirit of the invention. In other circumstances, specific details may be omitted so as not to obscure the invention. Nonetheless, the disclosure is written as to enable one skilled in the art to practice the teachings of the embodiments of the invention without undo experimentation.

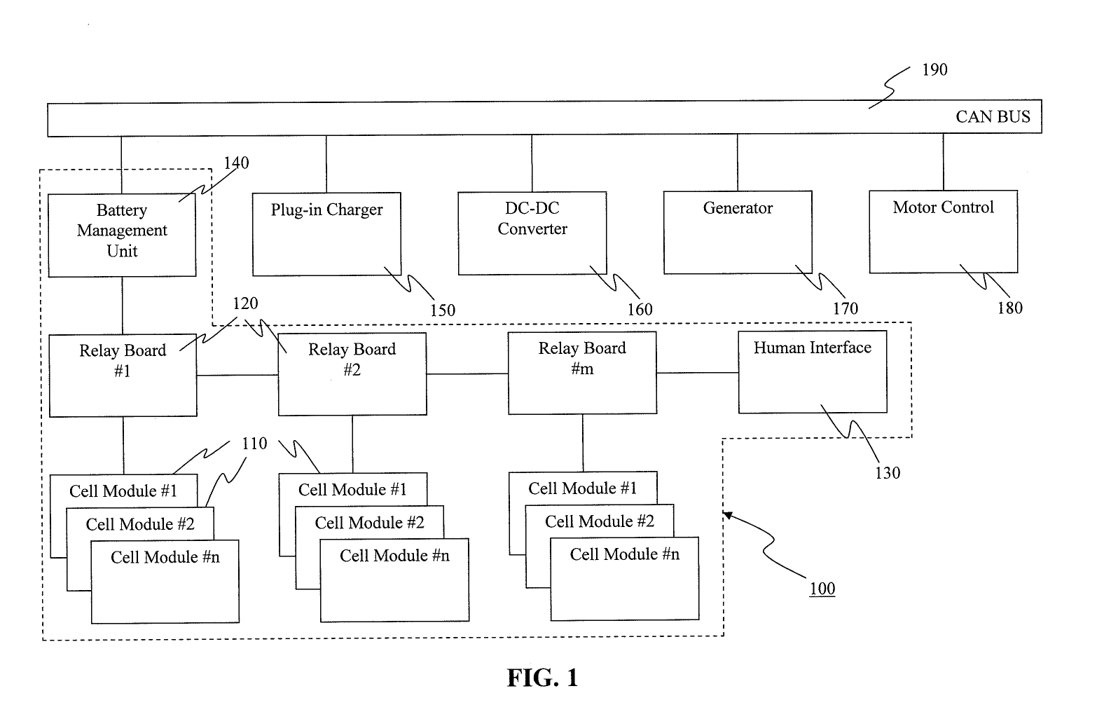

FIG. 1 is a block diagram showing an exemplary vehicle battery system 100 according to an embodiment of the claimed invention. The vehicle battery system 100 includes a number of battery cell modules 110 dividing into groups. The battery cell modules 110 in each group are connected to a same relay board 120. The relay boards 120 relay signals from the corresponding battery cell modules 110 to battery management unit 140. According to FIG. 1, as an example, each relay board 120 are connected to n cell modules 110, while there are altogether m relay board 120 in the vehicle battery system 100. Therefore, the electricity of the vehicle battery system 100 is supplied by a total number of m×n cell modules 110.

According to an embodiment of the claimed invention, the battery management unit 140 receives discharge status of cell modules 110 and based on which responds by sending control signals to cell modules 110 in order to balance the discharge of the cell partitions (not shown) within the cell modules 110. In one exemplary embodiment, the relay boards 120 are also in communication with a human interface unit 130, through which the user can read out the status of the cell modules 110 and the battery management unit 140. In one exemplary embodiment, the battery management unit 140 enables user to control the setting and operation of the battery management unit and cell modules, for example, setting the speed of switching circuits (not shown) for equalizing charges between battery cell partitions (not shown), the voltage boost up ratio of the DC-DC step up converters (not shown) in the cell monitor unit (not shown), or the threshold voltage to end discharging process.

According to an embodiment of the claimed invention, the battery management unit 140 communicates with other components in the vehicle system through a network bus 190. Such other components includes plug-in charger 150, for connecting to external electrical energy source for charging the battery cells; DC-DC converter 160, for converting the voltage delivered by the vehicle battery system 100 to the operating voltages of various components in the vehicle; generator 170, for converting mechanical energy of the vehicle system to electrical energy such that the battery system can be charged under specific situations such as regenerative breaking; motor control unit 180, for driving the vehicle motor and causing wheel rotation, and hence putting the vehicle into motion.

The communication between the battery management unit 140 with other components may be performed in broadcast-and subscribe-manner, wherein the sender (or publisher) broadcasts messages to a broadcast bus (not shown) such as the Controller Area Network bus (CAN-bus). Receiver (or subscriber), on the other hand, subscribes messages based on various criteria. During communication, messages flow from the sender to the receivers according to the subscriptions.

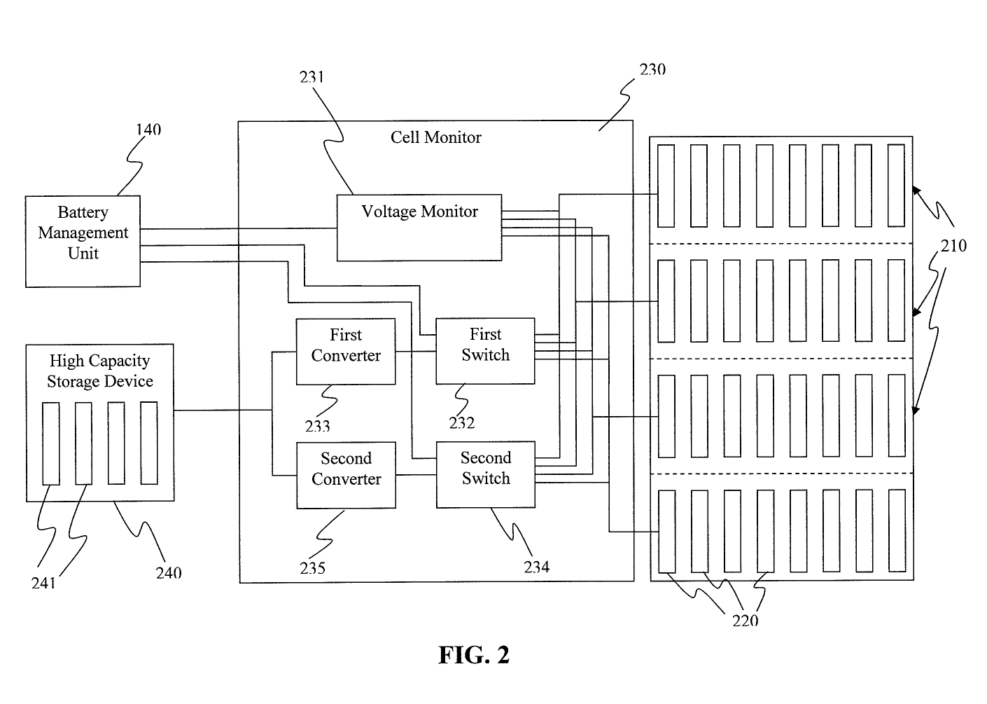

FIG. 2 is a block diagram showing an exemplary configuration of the cell module, such as presented in FIG. 1. According to an exemplary embodiment, the cell module includes a number of battery cell partitions 210 connected in series configuration (connection not shown). Each battery cell partition 210 further contains a number of battery cells 220 connected in parallel configuration (connection not shown). The terminals of each battery cell partition 210 are connected to cell monitor 230.

According to an exemplary embodiment, the cell monitor 230 includes a voltage monitor 231, for measuring the terminal voltages of each battery cell partition 210 and reporting the measurement result to the battery management unit 140. The cell monitor 230 further includes a first switching circuit 232, for connecting the highest capacity battery cell partition 210 to a first DC-DC step up converter 233 based on control signals given by the battery management unit 140. The first DC-DC step up converter 233 boosts up the voltage level to facilitate the charge transfer from the highest capacity battery cell 210 to a high capacity storage device 240. In one exemplary embodiment, the high capacity storage device 240 consists of charge sharing battery cells 241 similar to those forming the battery cell partitions 210. The charge sharing battery cells 241 in the high capacity storage device 240 are connected in parallel configuration to provide comparable charge capacity as a single battery cell partition. In another exemplary embodiment, the high capacity storage device 240 contains charge sharing capacitors.

According to one exemplary embodiment, the cell monitor 230 further includes a second switching circuit 234 for connecting the lowest capacity battery cell partition 210 directly to the high capacity storage device 240 based on control signals from the battery management unit 140, such that the charge in the high capacity storage device 240 is transferred to the lowest capacity battery cell partition 210. As a result, the charge capacities between various battery cell partitions 210 can be equalized and balanced.

According to a further embodiment, the second switching circuit 234 connects the lowest capacity battery cell partition 210 to a second DC-DC step up converter 235 based on control signals from the battery management unit 140. The second DC-DC step up converter 235 boosts up the voltage level from the high capacity storage device 240 to facilitate the charge transfer from the high capacity storage device 240 to the lowest capacity battery cell 210.

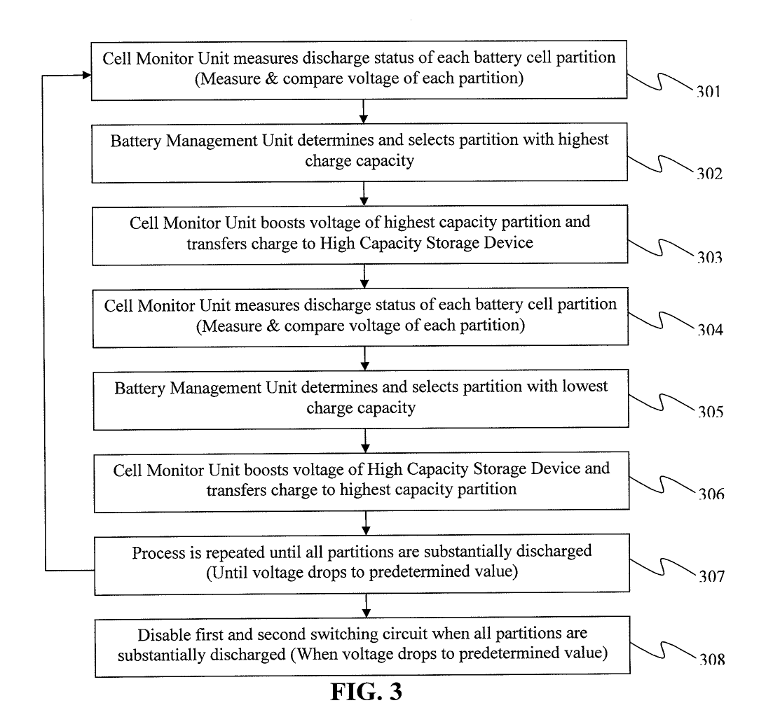

FIG. 3 is a flow diagram illustrating the process of discharge balancing according to an embodiment of the claimed invention. At step 301, cell monitor unit measures discharge status of each battery cell partition. The battery cell partitions contain battery cells electrically connected in parallel configuration. In an exemplary embodiment, each battery cell partition is designed into a uniform configuration, such as having same number of battery cells and giving comparable voltage output. In an exemplary embodiment, the discharge status of each battery cell partition is obtained by measuring the output voltage of each battery cell partition. In one exemplary embodiment, voltage measurement can be done by comparing the output voltage of a battery cell partition through a plurality of voltage comparators with different reference voltages. In another exemplary embodiment, the output voltage of a battery cell partition can be fed into voltage dividers of different dividing ratio, or a resistor ladder. The various outputs of the voltage dividers are compared to a predetermined reference voltage sequentially through a comparator. The results of the comparison made by voltage comparator can be represented by flags and stored in registers or memory units.

In a further exemplary embodiment, the output voltage of a battery cell partition can be measured by analog-to-digital converters (ADC), which can be implemented by direct conversion ADC, successive approximation ADC, ramp-compare ADC, delta-coded ADC, pipeline ADC, and Sigma-Delta ADC. The ADC converts the continuous voltage at the battery cell partition output. The result of the conversion is represented by discrete digital signals which can also be stored in registers or memory units.

At step 302, battery management unit determines from the discharge status measurement results and selects the battery cell partition with the highest charge capacity. This corresponds to battery cell partition that gives the highest voltage output. In one exemplary embodiment, each battery cell partition is assigned with an address. By comparing the contents of registers or memory units that represent the voltage value output by the corresponding battery cell partition, the address of the partition with the highest output voltage, meaning the highest charge capacity, is stored in a register or memory unit.

At step 303, cell monitor unit refers to the register or memory unit that stores the address of the battery cell partition having the highest charge capacity and controls a first switching circuit to connect the voltage output of the highest charge capacity partition to the input of a DC-DC step up converter. The DC-DC step up converter converts the voltage of the highest charge capacity partition to a higher voltage level than the voltage of a high capacity storage device. The output voltage of the step up converter is connected to the high capacity storage device. As such, charge is transferred efficiently from the highest charge capacity partition to the high capacity storage device under voltage difference. In one exemplary embodiment, the high capacity storage device consists of battery cells similar to those forming the battery cell partitions. The battery cells in the high capacity storage device are connected in parallel to provide comparable charge capacity as a single battery cell partition. In an exemplary embodiment, the DC-DC step up converter can be implemented by switched-mode converter as known to those of the art.

In one exemplary embodiment, step 303 lasts for a predetermined period of time and processing continues at step 304. In another exemplary embodiment, the predetermined period of time can be adjusted by the battery management unit.

At step 304, cell monitor unit measures discharge status of each battery cell partition. In an exemplary embodiment, similar to step 301, the discharge status can be determined by measuring the output voltage of each battery cell partition. Similar to step 301, the measurement of output voltage may be made by voltage comparators or ADC. The result of measurement can be stored as register flags, digital values in registers or memory unit.

At step 305, battery management unit determines and selects the battery cell partition with the lowest charge capacity. This corresponds to battery cell partition that gives the lowest voltage output. In one exemplary embodiment, similar to step 302, the contents of registers or memory units that represent the voltage value output by the corresponding battery cell partition are compared. The address of the partition with the lowest output voltage, meaning the lowest charge capacity, is stored in a register or memory unit.

At step 306, the cell monitor unit transfers the charge in the high capacity storage device to the lowest capacity battery cell partition. In one exemplary embodiment, the cell monitor unit includes a second switching circuit. Based on the register or memory unit that stores the address of the battery cell partition having the lowest charge capacity, the second switching circuit connects the voltage terminals of the high capacity storage device to the lowest capacity battery cell partition such that charge is transferred from the high capacity storage device to the lowest capacity battery cell partition by charge sharing.

In another exemplary embodiment, the cell monitor includes a DC-DC step up converter and a second switching circuit. The second switching circuit connects the voltage output of the high capacity storage device to the input of the DC-DC step up converter. The DC-DC step up converter converts the voltage of the high capacity storage device to a higher voltage level than the voltage of the lowest capacity battery cell partition. The output voltage of the step up converter is then connected to the terminals of the lowest capacity battery cell partition. As such, charge is transferred efficiently from the high capacity storage device to the lowest charge capacity partition under voltage difference. In an exemplary embodiment, the DC-DC step up converter can be implemented by switched-mode converter as known to those of the art.

In one exemplary embodiment, step 306 lasts for a predetermined period of time and processing continues at step 307. In another exemplary embodiment, the predetermined period of time can be adjusted by the battery management unit.

Accordingly, the effect of the process from step 301 to step 306 is to improve the balance or to equalize the charge capacity between various battery cell partitions.

At decision step 307, the discharge status of each battery cell partition is monitored. As in step 301, the discharge status can be determined by measuring the output voltage of the corresponding battery cell partition. Processing continues to step 308 if all partitions are substantially discharged. In an exemplary embodiment, a battery cell partition is considered as substantially discharged when its output voltage drops to a predetermined threshold value. Otherwise, processing loops back to step 301.

At step 308, the first and second switching circuits are disabled, and the battery cell module stops delivering electricity to the system.

### INDUSTRIAL APPLICABILITY

The arrangements described are applicable to the battery industries and particularly for battery charging system for heavy duty rechargeable batteries, including batteries for Battery Electric Vehicles (BEV), hybrid vehicles, submarines, load leveling machines and capacitor arrays in superconductor applications. The arrangements are especially suitable for battery arrays that require optimization of the discharging process.

The foregoing description of embodiments of the present invention are not exhaustive and any update or modifications to them are obvious to those skilled in the art, and therefore reference is made to the appending claims for determining the scope of the present invention.

We claim:

1. A method for discharge balancing for a battery array including a plurality of partitions of battery cells, comprising:
pumping charge from a first partition of battery cells to a high capacity storage device; and
transferring charge from said high capacity storage device to a second partition of battery cells;
wherein the capacity of said first partition of battery cells is higher than the capacity of said second partition of battery cells.

2. The method for discharge balancing according to claim 1, further comprising determining the discharge status of each partition of battery cells, wherein said transferring charge to said high capacity storage device is performed from a partition of battery cells with the highest charge capacity.

3. The method for discharge balancing according to claim 2, wherein said step of determining the discharge status of each said partition of battery cell is by measuring the voltage across the terminals of the corresponding partition of battery cells.

4. The method for discharge balancing according to claim 1, further comprising determining the discharge status of each partition of battery cells, wherein said transferring charge from said high capacity storage device is performed to a partition of battery cells with the lowest charge capacity.

5. The method for discharge balancing according to claim 4, wherein said step of determining the discharge status of each said partition of battery cell is by measuring the voltage across the terminals of the corresponding partition of battery cells.

6. The method for discharge balancing according to claim 1, wherein said transferring charge from said first partition of battery cells to said high capacity storage device further comprises:
boosting the voltage of said first partition of battery cells to a boosted voltage; and
connecting the boosted voltage to said high capacity storage device.

7. The method for discharge balancing according to claim 1, wherein said transferring charge from said high capacity storage device to said second partition of battery cells is performed by charge sharing between said high capacity storage device and said second partition of battery cells.

8. The method for discharge balancing according to claim 1, wherein said transferring charge from said high capacity storage device to said second partition of battery cells further comprises:
boosting the voltage of said high capacity storage device to a boosted voltage; and
connecting the boosted voltage to said second partition of battery cells.

9. The method for discharge balancing according to claim 1, further comprising repeating said transferring charge from said first partition of battery cells and transferring charge from said high capacity storage device until all partitions of battery cells in said battery array are substantially fully discharged.

10. The method for discharge balancing according to claim 1, further comprising repeating said transferring charge from said first partition of battery cells and transferring charge from said high capacity storage device until the voltage across each partition of battery cells drops to a predetermined value.

11. The method for discharge balancing according to claim 1, wherein said transferring charge from a first partition of battery cells to a high capacity storage device transfers charge to a charge sharing battery cell.

12. An apparatus for discharge balancing for a battery array including a plurality of partitions of battery cells, comprising:
a first switching circuit for transferring charge from a first partition of battery cells to a high capacity storage device; and
a second switching circuit for transferring charge from said high capacity storage device to a second partition of battery cells;
wherein the capacity of said first partition of battery cells is higher than the capacity of said second partition of battery cells.

13. The apparatus for discharge balancing according to claim 12, further comprising a voltage comparator for determining the discharge status of each partition of battery cells, wherein said first switching circuit transfers charge to said high capacity storage device from a partition of battery cells with the highest charge capacity.

14. The apparatus for discharge balancing according to claim 12, further comprising a voltage comparator for determining the discharge status of each partition of battery cells, wherein said second switching circuit transfers charge from said high capacity storage device to a partition of battery cells with the lowest charge capacity.

15. The apparatus for discharge balancing according to claim 12, wherein said first switching circuit further comprises:
a boosting circuit for boosting the voltage of said first partition of battery cells to a boosted voltage; and
a buffering circuit for connecting the boosted voltage to said high capacity storage device.

16. The apparatus for discharge balancing according to claim 12, wherein said second switching circuit further comprises a charge sharing circuit for transferring charge from said high capacity storage device to said second partition of battery cells.

17. The apparatus for discharge balancing according to claim 12, wherein said second switching circuit further comprises:
a boosting circuit for boosting the voltage of said high capacity storage device to a boosted voltage; and
a buffering circuit for connecting the boosted voltage to said second partition of battery cells.

18. The apparatus for discharge balancing according to claim 12, further comprising a controlling circuit for disabling said first switching circuit and said second switching circuit when all partitions of battery cells in said battery array are substantially fully discharged.

19. The apparatus for discharge balancing according to claim 12, further comprising a controlling circuit for disabling said first switching circuit and said second switching circuit when the voltage across each partition of battery cells drops to a predetermined value.

20. The apparatus for discharge balancing according to claim 12, wherein said high capacity storage device further comprises at least one charge sharing battery cell.
